(19) United States
(12) Patent Application Publication
(10) Pub. No.: US 2004/0128698 A1
(43) Pub. Date: Jul. 1, 2004

(54) Apparatus and methods for scheduling events

(76) Inventors: Helena Goldfarb, Niskayuna, NY (US); Kevin Kenny, Niskayuna, NY (US); Jonathan Houlihan, Schenectady, NY (US); Jesse Schechter, Niskayuna, NY (US); Benjamin Verschueren, Niskayuna, NY (US); Li Liao, Clifton Park, NY (US); Jill Magsam, Schenectady, NY (US); Stephen Angelovich, Yonkers, NY (US); Michael Kinstrey, Ballston Spa, NY (US); Brion D. Sarachan, Schenectady, NY (US); Michael A. Woellmer, Troy, NY (US); David L. Henderson, Clifton Park, NY (US); Christopher Hammond, Schenectady, NY (US)

Correspondence Address: John S. Beulick, Armstrong Teasdale LLP, Suite 2600, One Metropolitan Sq., St. Louis, MO, 63102, US

(21) Appl. No.: 10/335,076

(22) Filed: Dec. 31, 2002

(51) Int. Cl. H04N 7/173; H04N 7/16; G06F 13/00; H04N 5/445

(52) U.S. Cl. 725/116; 725/97; 725/39; 725/146

(57) ABSTRACT

A television network broadcast system includes a scheduling component that includes a user interface accessible by all users who contribute to the creation of a schedule and a plurality of nodes configured to perform actions based on receipt of messages. The nodes include at least one of groups, filters, clients, and servers. The actions include at least one of pass the message along, take a specific action based on receipt of a specific message, block certain types of messages, and initiate new messages.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to scheduling and, more particularly to, a web-based system and method of scheduling events.

The scheduling of events, e.g., for a television broadcast schedule, is typically performed by users of the schedule. These users may utilize separate systems, some of which communicate with each other in batch mode while others do not communicate with each other at all. Due to the difficulty in communication between and among the users, it is often difficult to immediately alert all users of the schedule to scheduling changes. This lapse in notification may result in scheduling errors and outages.

### BRIEF DESCRIPTION OF THE INVENTION

In one aspect, a television network broadcast system is provided that includes a scheduling sub-system including a user interface accessible by all users who contribute to the creation of a schedule and a plurality of nodes configured to perform actions based on receipt of messages. The nodes include at least one of groups, filters, clients, and servers. The actions include at least one of pass the message along, take a specific action based on receipt of a specific message, block certain types of messages, and initiate new messages.

In another aspect, a method is provided for scheduling events utilizing a television network broadcast system including a scheduling component configured with a user interface accessible by all users who contribute to the creation of a schedule. The scheduling component includes a plurality of nodes configured to perform actions based on receipt of messages. The nodes include at least one of groups, filters, clients, and servers. The actions include at least one of pass the message along, take a specific action based on receipt of a specific message, block certain types of messages, and initiate new messages. The method comprises utilizing an Integration Controller component to accept events from the scheduling component and forward these events to real-time systems for frame accurate execution.

### BRIEF DESCRIPTION OF THE DRAWINGS

FIG. 1 illustrates an example of a node chain passing a series of messages.

FIG. 2 illustrates an application architecture for a television network broadcast system including a scheduler sub-system in accordance with one embodiment of the invention.

FIG. 3 illustrates a schematic view of the scheduler system shown in FIG. 2.

FIG. 4 illustrates an architecture for an Integration Controller node in accordance with one embodiment of the invention.

FIG. 5 illustrates an architecture for an IC User Interface node.

FIG. 6 illustrates an architecture for an MIS Event Handler node.

FIG. 7 illustrates an architecture for a Display Manager node.

FIG. 8 illustrates an architecture for an IC Server node.

FIG. 9 illustrates an architecture for a Control and Logic node.

FIG. 10 illustrates an architecture for a Redundant On-Air Server node.

FIG. 11 illustrates an architecture for a Studio IC node.

FIG. 12 illustrates a schedule screen including a highlighted entry.

FIG. 13 illustrates a map screen 310 showing station feeds for the highlighted entry shown in FIG. 12.

FIG. 14 illustrates a screen showing station groups for the highlighted entry shown in FIG. 12.

### DETAILED DESCRIPTION OF THE INVENTION

A scheduling system provides a common interface used by everyone who contributes to the creation of a broadcast schedule to streamline functions, reduce errors and outages, and provide a single consistent view of the schedule. The system includes a plurality of message handlers, or nodes, that communicate with each other by transmitting messages to other nodes. Nodes are objects which take action based on receipt of messages. Applications are constructed out of these nodes. Interacting sets of nodes are assembled within one process or multiple processes. These processes are able to run on the same machine or on multiple machines, even across different operating systems. Nodes are generally arranged in a hierarchy, but can also fan-in to form a network configuration.

Important types of nodes include groups (which distribute messages to all of their children), filters (which stop the flow of certain types of messages, or which may initiate new messages), clients (which send messages to other processes, often to request a service of some type), and servers (which receive messages from other processes and perform services in response to these messages). Group nodes allow fan-in as well as fan-out. The system also implements different types of events, including composition, distribution, and group events. As used hereinafter, an event is a data record describing the timing, hardware path, and possibly other information for execution.

The processing of messages by nodes follows a pipeline pattern in which messages flow from node-to-node and the nodes perform one of the following functions. They pass the message along, take a specific action based on receipt of a specific message, block certain messages, and initiate new messages based on receiving other messages, based on time, or based on user input. The use of nodes in the system allows for flexibility and extensibility of the system.

FIG. 1 illustrates an example of a node chain passing a series of messages. Message A is passed from Node1 to Node3 through Node2. Message B is blocked by Node2 and is not passed to Node3. Message C is passed from Node1 to Node2 which generates Message D that is passed to Node3.

Exemplary embodiments of methods and systems for scheduling events, such as for a broadcast company are described below. In one embodiment, the system provides a common interface accessed by users to contribute to the creation of a broadcast schedule to streamline functions, reduce errors and outages, and provide a single, consistent view of the schedule. With the message-based architecture of the system, the system operates in real time. All actions taken by one user are broadcast to all users of the system as soon as the action is taken. Different users may access the system through different applets with a different set of underlying nodes to process the message, but all users connect to the same server and the same information.

The methods and systems are not limited to the specific embodiments described herein. In addition, method and system components can be practiced independent and separate from other components described herein. Also, each component can be used in combination with other components.

The architecture includes a series of nodes connected together in a virtual chain. Each node registers with other nodes that it is interested in communicating with. This communication is directional and non-cyclical. One or more listeners register with a node to receive messages going downstream and a different set of listeners register with the node to receive messages going upstream. The listener relationship is reciprocal, e.g., if NodeA has NodeB registered as a listener for downstream messages, NodeB has NodeA registered as a listener for upstream messages. A node can have 0, 1, or many nodes connected to it in each direction. The listeners are not ordered and the set of listeners is stored in a message adapter.

The adapter utilizes a set of methods to accept messages. The adapter works with a message class in a Visitor pattern so that each message is handled by an appropriate method for the particular type of message. There is a generic method in the adapter, or adapter class, that accesses a dispatch method in the message class. The dispatch method accesses the specific accept message method in the adapter class for the particular type of message.

There are two types of adapters—a relay adapter and a filter adapter. The different types of adapters have different default behaviors in the accept message method. A relay adapter sends the messages onto each of its listeners. This type of adapter is typically used in a node configured to recognize a particular type of message and pass all other message types directly onto its listeners. A filter adapter stops all messages and does not pass them on to the listeners. Filter adapters are used in a node whose functionality mimics a filter which stops the majority of the messages that come to it, but passes a few through. For example, there may be several types of messages in the system including create, delete, and move messages. However, there may also be a set of functionality in the system that specifically addresses delete messages. Since the functionality is configured to recognize only one type of message, the functionality is connected to a node with a filter adapter. The accept message method can then be overridden with respect to delete within the adapter to pass those messages on. By default, the node and filter adapter stop all other messages and do not pass them on. For example, a system includes three nodes, Node1, Node2, and Node3 connected in a chain and three messages are to be passed between the nodes, Message1, Message2, and Message3. Node2 passes all three message types down from Node1 to Node3, but only passes messages of type Message2 upward from Node3 to Node1. In that case, the downward adapter is a relay adapter and the upward adapter is a filter adapter. For the downward activity, the default behavior is the desired behavior for each message so none of the accept message methods have to be overridden. However, for messages of type Message2 to be passed up from Node3 to Node1, the accept message method for Message2 has to be overridden to allow proper processing and then the message is sent to Node1.

Each system message carries information within it. For example, a delete message may simply carry a unique identifier for the item we want to delete but a create message may carry several parameters input by a user that define the item we wish to create. Any node in the chain through which the message passes may access this information.

Each message can have zero to many reply listener objects. Reply listener objects are associated with a node. The node adds a reply listener to a message if the node has indicated an interest in the reply to that message. The replies are only presented to nodes that have added a reply adapter to the message within their accept message method in the adapter. The reply listeners know which reply listener is next in the chain of handling points. This information can be used to obtain a backtrace of the reply path. The reply adapter also keeps a count of the outstanding references to itself. The reference count is incremented each time a message is presented for processing to the adapter, and each time an additional reply adapter object is created that refers to this reply adapter. The reference count is decremented when the reply listener completes dispatching the message. It is also decremented after the finish method is accessed on any reply adapter object that refers to this reply adapter.

In addition, the node that creates a reply adapter invokes its dismiss method once it has finished processing and has presented all the messages it intends to present to the reply adapter. When all objects that use a given reply adapter have dismissed it (reference count=0), the adapter's finish method is invoked. This method is used to send additional replies (e.g., to summarize status), to initiate new messages, to release system resources and similar clean up tasks, etc. After the finish method is invoked, the next reply listener in the virtual circuit is dismissed, possibly firing its finish method, and so on. Similar to the message adapter, the reply adapter class co-operates with the message class in the Visitor pattern. The reply adapter directs the message to dispatch itself to the type-specific, overloaded accept reply method on the adapter. The default behavior for reply adapters is to pass the reply to the next reply adapter in the chain.

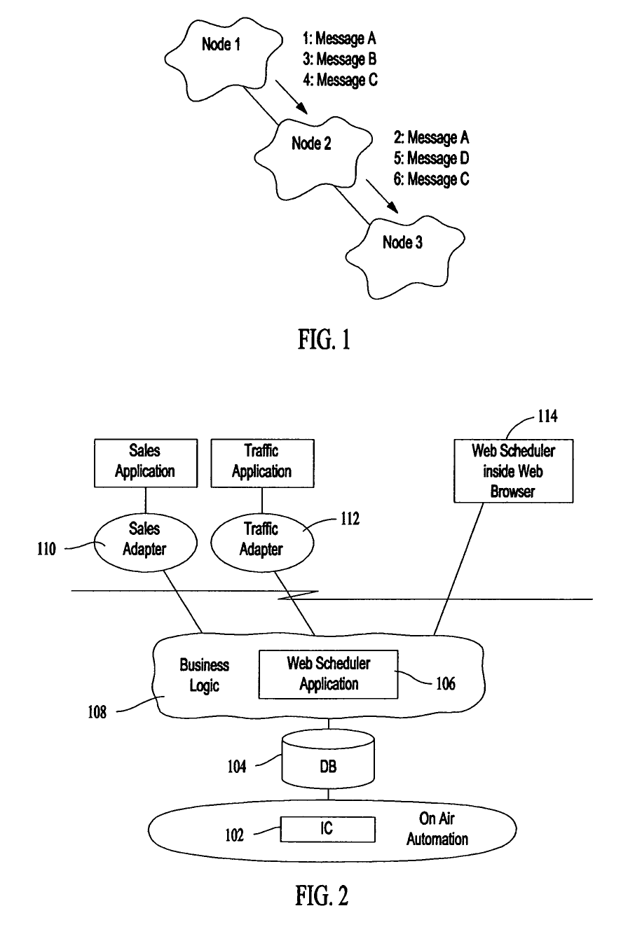

FIG. 2 illustrates an application architecture for a television network broadcast system 100 that includes an Integration Controller (IC) 102 connected to a database 104 which is accessible by a Webscheduler application 106. A layer of business logic 108 surrounds webscheduler application 106. Webscheduler application 106 is connected to a plurality of webscheduler adapters through the Internet. The webscheduler adapters include a sales adapter 110, a traffic adapter 112, and at least one Webscheduler 114 run inside a web browser.

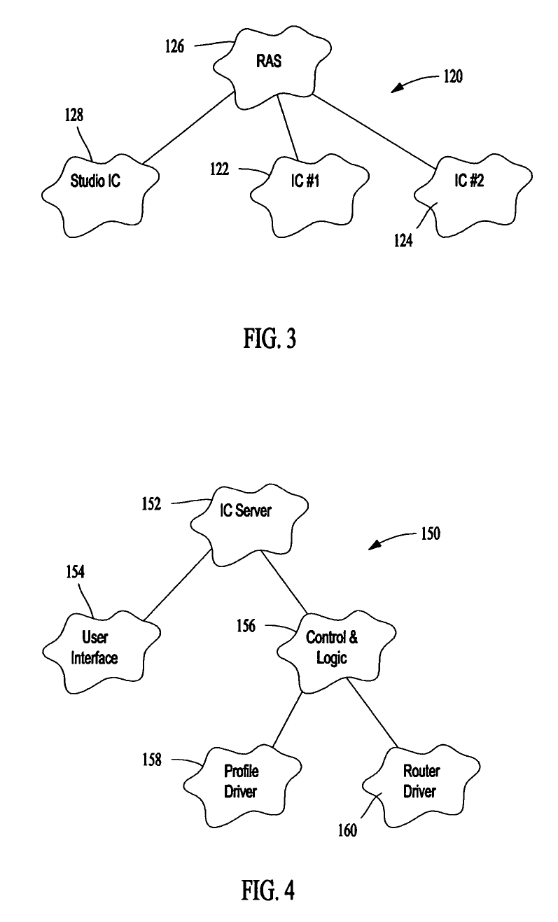

More particularly, FIG. 3 illustrates a television network broadcast system 120 that includes a first IC 122, a second IC 124, a Redundant On-Air Server (RAS) 126, and a Studio IC 128. A Take, as used hereinafter, is the action of running an approximate time event and all of its dependents. Although each application is able to run on a separate computer, in one embodiment, all of the applications run on a single computer. The IC is built using a NetSys software library that uses messages which are sent to the nodes. In one embodiment the software is compatible with both Solaris and NT. In an alternative embodiment, the Redundant On-Air Server and the ICs are typically run on Windows NT.

Nodes share a common interface and can be assembled in any configuration because each node can be attached to any other node. This configurability provides flexibility in adding new functionality by reusing existing nodes for new applications. Although the nodes are described in the context of an IC architecture, the nodes which make up the IC applications can easily be assembled in different configurations. In addition, groups of nodes can be reconfigured to run in different processes or on different machines while retaining the same functionality.

The integration controller accepts events from the scheduling system and forwards these events to various real-time systems (playback systems, video routers etc.) for frame accurate execution. Communication with the various real-time systems is via Ethernet LAN using industry standard protocols, i.e., TCP/IP. As events are executed the real-time systems send status and/or error messages back to the Integration Controller. The Integration Controller monitors these return messages, updates its displays and forwards pertinent information to the scheduling system for display and appropriate operator action as needed.

The Redundant On-Air Server contains a cache (an in-memory store of data, usually event data) of all composition event data for all ICs. The Redundant On-Air Server receives Take messages, performs all required edits to the Taken event and all of its tied and offset events, and then distributes ProcessEvent messages for all the events that have been updated by the Take. The Redundant On-Air Server supports Takes that effect more than one IC, since all IC data is cached in the Redundant On-Air Server. In addition, the Redundant On-Air Server caches other types of event data such as distribution events, and implements logic for the association between composition and distribution events. In one aspect, all systems and components, including the integration controllers, are connected to RAS 126 and the messages pass through RAS 126.

The Studio IC application provides a subset of the IC functionality, including the ability to perform Takes (initiate Take messages), at a studio location. The Studio IC also includes additional non-IC functionality such as the ability to set up break-ins.

I. IC Architecture

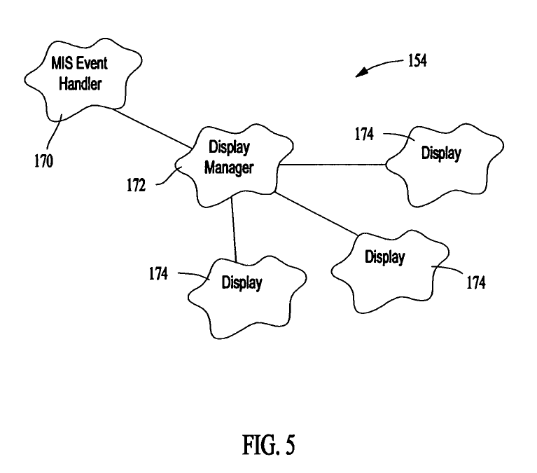

FIG. 4 illustrates an IC architecture in accordance with one embodiment of the invention. An IC 150 includes an IC Server 152, connected to a User Interface 154, and a Control & Logic 156 which is connected to a Profile Driver 158 and a Router Driver 160. IC 150 is implemented using a C++ NetSys software library for messaging and control, and Tc1/Tk for a graphical user interface (GUI) layer. The workstation portion of IC 150 is structured as three processes: IC Server 152, User Interface 154, and Control & Logic 156. These three processes typically run together on one computer although in alternative embodiments, they run on separate computers. IC 150 also includes driver processes. The number of driver processes depends on the number and type of devices being controlled and monitored by IC 150. The drivers typically run on the same computer as the other IC processes.

Each IC is configured (via a configuration file) to accept composition events for a pre-defined number of channels. A channel, as used hereinafter, refers to an output stream from the video execution (IC) portion of the scheduler. In one embodiment, each IC is configured to accept composition events for up to four channels. The pre-defined number of channels is, in one embodiment, a result of user interface screen layout. Alternatively, a greater, or lesser, number of channels is accommodated by developing a different screen layout.

IC Server 152 is an entry point for messages into IC 150. Incoming messages are frequently ProcessEvent messages that each contain an event of any type. For ICs, these events are typically composition events. If it is desirable for IC 150 to monitor distribution (Skypath) execution, then distribution events are also sent to IC 150 via ProcessEvent messages. Additional messages that are sent to IC Server 152 include messages to SwitchLists (i.e. switch to a different contingency) and Take messages. As used hereinafter, a contingency occurs because each purpose may have multiple contingencies, only one of which can be run. A purpose, as used hereinafter, is a logical grouping of scheduled events (e.g. NFL or Prime Time). IC Server 152 distributes its incoming messages to User Interface 154 and Control & Logic Processes 156. Since IC Server 152 is the entry point into IC 150, it includes functionality that pertains to the entire IC, such as event integrity checks on incoming data, filtering incoming event data to select only events for that IC's channels, and performing takes that effect only the local IC. As used hereinafter, event integrity checks are tests to ensure that events are valid for execution. Status messages and as-run (EventOccurred) messages are sent upstream from IC Server 150. Likewise, status messages received by IC Server 150 from Control & Logic 156 are sent upstream, and reflected downstream to User Interface process 154 for display.

User Interface 154 receives ProcessEvent messages and other messages, e.g., Take, SwitchLists, from IC Server 152. User Interface process 154 provides various GUI displays portraying this information to the operator. In addition, User Interface 154 also receives status information from IC Server 152 which originated in Control & Logic 156 or upstream of IC Server 152.

User Interface process 154 also provides emergency editors which launch appropriate messages upstream, i.e., ProcessEvent messages originating from the event editor. User Interface process 154 also contains its own event execution simulator (the EventListManager) which provides time, countdown, and the executing event information to the displays.

Control & Logic 156 receives event data from IC Server 152 and distributes this data to device drivers. Control & Logic 156 also receives asynchronous status messages from drivers which it propagates upstream. In addition, Control & Logic 156 receives as-run messages from drivers, and logic for combining the as-run messages for each single event (coming from multiple devices) into a single as-run message which then propagates upstream. Error and time-out conditions are also recognized and propagated upstream as errors.

The device drivers receive event messages from Control & Logic 156, map these messages into the appropriate device specific commands, and return appropriate status and as-run messages.

The Redundant On-Air Server is implemented as a single process whose architecture is similar to that of IC User Interface process 154 (described below).

The Studio IC is implemented as a single process and has an architecture similar to that of the IC User Interface process. The differences are that only 1 channel (the main net) is shown rather than multiple channels and the Studio IC has a special client connection to the Redundant On-Air Server. The Studio IC's take button sends a Take message to the Redundant On-Air Server, rather than performing the take locally.

FIG. 5 illustrates an architecture for IC User Interface 154 that includes an MIS Event Handler 170 connected to a Display Manager 172 connected to a plurality of displays 174. IC User Interface 154 displays the execution of events and other information such as material management and device status. Local editors are also provided. IC User Interface 154 contains an event execution simulator known as the EventListManager which provides clock, countdown, and event transition information. IC User Interface 154 includes two major sections; MIS Event Handler 170 and Display Manager 172.

II. MIS Event Handler Architecture

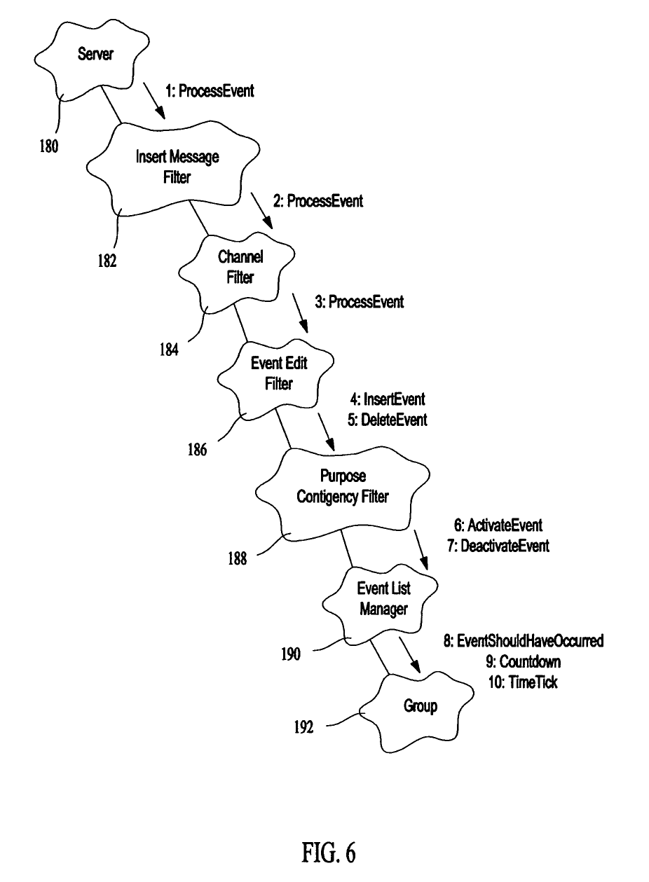

FIG. 6 illustrates an architecture for MIS Event Handler 170 that includes a server 180 connected to an Insert Message Filter 182 connected to a Channel Filter 184 connected to an Event Edit Filter 186 connected to a Purpose Contingency Filter 188 connected to an Event List Manager 190 which is connected to a Group 192. The NetSys library includes a facility for grouping a series of nodes to form a reusable message handling pipeline. Such a grouping may itself be plugged together with other nodes as though it were a single, complex node. These grouped node pipelines are termed meganodes. MIS Event Handler 170 is one such meganode, and is implemented as a pipeline of the simpler node types described below.

MIS Event Handler 170 begins with Server node 180 which is capable of receiving NetSys messages from external processes and terminates in Group 192 which allows other nodes to receive its output. For the User Interface, these messages are typically ProcessEvent or status messages coming from IC Server 152 (shown in FIG. 4).

Insert Message Filter 182 is a point from which NetSys messages can be injected from other nodes within User Interface 154. Uses for filter 182 include ProcessEvent messages from a flat file or from the local event editor. All messages originating from the previous stage (i.e. Server node 180) are passed through unchanged.

Channel Filter 184 passes all messages unchanged except that each ProcessEvent message, if it contains a composition event, is only allowed to pass if that event's channel is one of the channels handled by the IC. Otherwise the message containing the composition event is blocked by Channel Filter 184. IC User Interface 154 allows the events for a predetermined number of channels to be displayed. In one embodiment, the predetermined number of channels is four, due to the screen layout.

Event Edit Filter 186 maintains the in-memory cache of event data, which is also known as the EventDictionary. This cache is an up-to-date local copy of the events for some time threshold, e.g., 6 hours, into the future. Event Edit Filter 186 receives ProcessEvent messages, and as a result of these messages maintains the appropriate data in the EventDictionary and also originates InsertEvent and DeleteEvent messages. Messages other than ProcessEvent type messages are passed through EventEditFilter 186.

There are three distinct cases of event data updates that can arise based on ProcessEvent messages. The first case is for a new event which is not yet stored in the EventDictionary. For a new event, a copy of the event is retained, and an InsertEvent message is originated for downstream nodes. The second case is for an action to remove the event from the EventDictionary. The event's delete flag is set to indicate the action. Once this action is completed, a DeleteEvent message is originated for downstream nodes. The third case is for an event already in the EventDictionary wherein the ProcessEvent message contains modified data fields for this event. In this case, a DeleteEvent message is originated containing the old event data, the EventDictionary is updated to contain the new data, and an InsertEvent message is originated containing the new event data.

The result of the above processing is that the cache (EventDictionary) maintains the current correct version of the event data, and downstream nodes are sent appropriate InsertEvent and DeleteEvent messages. Each original ProcessEvent message is also passed onto downstream nodes, so that these nodes have the option of handling the data update in either form (ProcessEvent or Insert/DeleteEvent).

In one embodiment, the cache is implemented using a single EventDictionary, which is indexed by event identifier. In an alternative embodiment, events of different types will be addressed in the same process, and these events share identifiers. For example, in Profile driver 158 (shown in FIG. 4), a composition event generates a play and switch event, and these all have the same identifier. To support this composition event, the cache includes multiple dictionaries, one for each distinct type of event.

Purpose Contingency Filter 188 tracks which contingencies are active (i.e. which contingencies have been selected). Purpose Contingency Filter 188 maintains an event cache for each contingency. These event caches are maintained using the InsertEvent and DeleteEvent messages originating from the Event Edit Filter 186. Purpose Contingency Filter 188 also handles SwitchLists messages. Each SwitchLists message contains a selected contingency for a given purpose. Purpose Contingency Filter 188 records which contingency has been selected for each purpose.

For any Insert/DeleteEvent message received, if the event's contingency is the active one, Purpose Contingency Filter 188 originates an ActivateEvent or DeactivateEvent message, respectively. If the event's contingency is NOT the active one, no additional messages are originated.

When a SwitchLists message is received, a new contingency has been selected for a purpose. If there had been a previously-selected contingency, appropriate DeactivateEvent messages are generated for all of the old contingency's events. Appropriate ActivateEvent messages are generated for all of the new contingency's events, The result is that downstream nodes simply monitor Activate/DeactivateEvent messages to correctly maintain the set of active events.

In summary, event-handling nodes downstream of Purpose Contingency Filter 188 generally either handle Insert/DeleteEvent messages if ALL events are of interest, or Activate/Deactivate messages if only active events (on selected contingencies) are of interest. The latter case is typically more common than the former, since events on selected contingencies are the events that actually execute. The former case is utilized for contingency displays that show the alternative events and, in one embodiment, is also used for devices such as the Profile that internally support alternate lists.

Event List Manager (ELM) 190 simulates the execution of events, provides event transitions and countdowns, supports takes, and provides event list data integrity checks, such as checking for overlapping events. ELM 190 receives event data via ActivateEvent and DeactivateEvent messages. The ELM's data includes active contingencies, which is appropriate since alternative schedules do not execute. ELM 190 organizes its events into executing lists, where there is one play list per channel and also an effects list per channel for each type of effect, such as a logo. As used hereinafter, an effect is a video or audio overlay to the primary video material being played

More generally, ELM 190 maintains one list per resource. For CWeb, there is one list per channel, with no effect. For drivers, there is a list for each internal Profile resource, e.g., CODEC, each read head, or for each router cross-point, for example.

ELM 190 implements the logic for four different event trigger types: real, approximate, tied, and offset. ELM 190 is clock driven and also handles Take messages. ELM 190 originates TimeTick messages (indicating the current time), Countdown messages, and EventOccurred messages.

In message flow scenarios, there are four different EventOccurred messages; EventShouldHaveOccurred, EventDidOccur, EventDidNotOccur, and DidTheEventOccur. The messages originated by ELM 190 are of the first (EventShouldHaveOccurred) variety.

Take messages are directed at one of the executing lists, and modify the start time of the first event in that list and all of its tied and offset events, and also sets the LaunchOnTime flags of all these events. These updates result in ProcessEvent messages—actually originated in Insert Message Filter 188—which flow through the pipeline and cause all appropriate data updates. Takes may also slide the next event pod in the list, if this pod is approximate time and sliding it is required to maintain the correct sequence of events. As used hereinafter, a pod is a grouping of short events, typically a set of commercials, that are to be run together.

ELM 190 also allows the ability to take an event, rather than taking a list. If the taken event is not first in its list, all preceding events are dropped. Event list integrity errors detected by ELM 190, such as event overlaps, result in Alarm messages being sent.

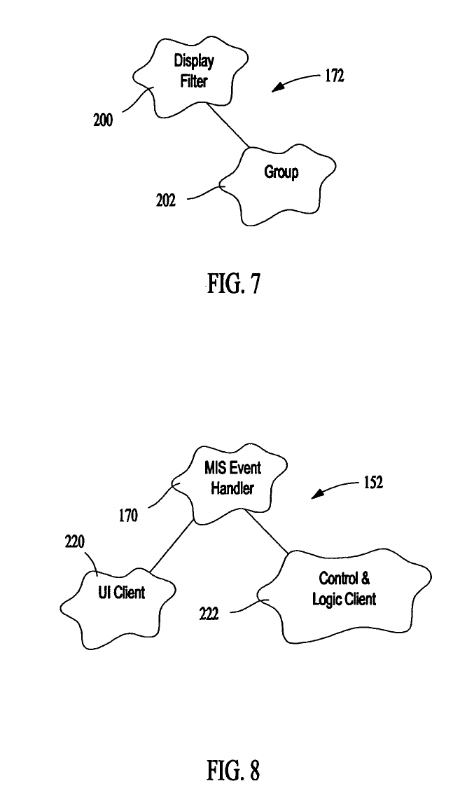

FIG. 7 illustrates an architecture for Display Manager 172 including a Display Filter 200 and a Group 202. Display Manager 172 translates NetSys messages into commands that update User Interface displays. Display Manager 172 also mediates among the displays such that the displays coordinate with each other through Display Manager 172 rather than directly communicating with one another. This architecture makes User Interface 154 (shown in FIG. 5) highly extensible as there is a well-defined Display Manager interface to which each display must conform. Any number of Display Manager-compatible displays can be plugged into the IC.

Display Manager 172 is structured as a meganode in which Display Filter 200 implements Display Manager-specific functionality, and Group node 202 provides the mechanism to install any number of displays into Display Manager 172.

Display Manager 172 receives all messages passed through and generated by MIS Event Handler 170 (shown in FIG. 5), including messages to Insert/Delete/Activate/Deactivate events, as well as EventShouldHaveOccurred, TimeTick, Countdown, and other messages.

Display Filter 200 maintains information that is shared among all displays, such as the currently-selected event. Display Filter 200 provides functions that any display can access, and which result in an appropriate message being broadcast to all displays. These functions include functions for setting and clearing the current selection, highlighting a given event, or responding to the Home button. Display Filter 200 also implements the flashing which occurs before event transitions based on receipt of the appropriate EventShouldHaveOccurrcd (soon) messages from Event List Manager 190.

Group node 202 behaves like any other NetSys Group—all messages Group 202 receives are routed to all Displays which are implemented using Tc1Nodes. Tc1Nodes call procedures implemented in the Tc1 programming language based on receipt of NetSys messages. Since the IC user interface displays are implemented using Tc1, the Tc1Node display objects invoke the appropriate UI updates based on messages received. Most displays that show event schedules respond to Activate/DeactivateEvent messages, since only events in the active contingencies are executed and displayed. The one exception is the Purpose/Contingency display which shows all events for all contingencies, and therefore responds to Insert/DeleteEvent messages rather than Activate/DeactivateEvent messages.

Following is a list of display types currently implemented in the IC, and the messages which drive them.

| Display | Description | Messages |
|---|---|---|
| Alarm Viewer | Display all alarms and errors | AlarmMessage |
| On-Air/Next | Display the event which is on-air and next | EventOccurred* |
| Display | for each channel, along with a countdown, | Countdown |
| | take button, and (not yet implemented) a | HighlightEvent |
| | hold button | HighlightField |
| | | ClearSelection |
| Clock(s) | Show time in digital or analog (clock face) form. | TimeTick |
| Integrated | Show all composition events organized by | ActivateEvent |
| Schedule | time | DeactivateEvent |
| | | HomeDisplay |
| | | EventOccurred* |
| | | HighlightEvent |
| | | Set/ClearSelection |
| | | HighlightField |
| Channel | Show all composition events listed by | ActivateEvent |
| Schedule | channel | DeactivateEvent |
| | | HomeDisplay |
| | | EventOccurred* |
| | | HighlightEvent |
| | | Set/ClearSelection |
| | | HighlightField |
| Contingency | Show all composition events organized by | SwitchLists |
| Display | purpose and contingency, allow | InsertEVent |
| | contingencies to be selected | DeleteEvent |
| | | EventOccurred* |
| | | HighlightEvent |
| | | Set/ClearSelection |
| | | HighlightField |
| Resource | Shows any IC resource allocations in | (none yet, currently |
| Allocations | timeline form | reads sample resource |
| | | data from a flat file) |
| Preview List | (not yet implemented) | |
| Material | Provides a viewer and editor for video | (none yet currently |
| Management | material that is loaded on the profile and | reads sample MMS |
| | in archives and for MMS events | data from a flat file and |
| | | randomly generates |
| | | MMS events) |
| Device Status | Shows the current status of the hardware | EventOccurred* |
| | path in terms of what is being played and | later: status messages |
| | (not yet implemented) the status of | |
| | hardware | |
| Editors | Provide a facility for local event edits in | ProcessEvent |
| | the form of a low-level (type-in) event | (generated rather than |
| | editor, and higher-level drag-and-drop pod editors | received) |
| Log Viewer | Allow logs to be browsed and viewed. | AlarmMessage |

*Specifically, EventShouldHaveOccurred.

IV. IC Server Architecture

FIG. 8 illustrates an architecture for IC Server 152 including MIS Event Handler meganode 170 connected to a UI Client 210 and a Control & Logic Client 212. Client nodes 210 and 212 route messages to User Interface 154 and to Control & Logic 156. This implementation supports the downward flow of messages, and also allows filtering and integrity checks to be performed upon message entry into the IC.

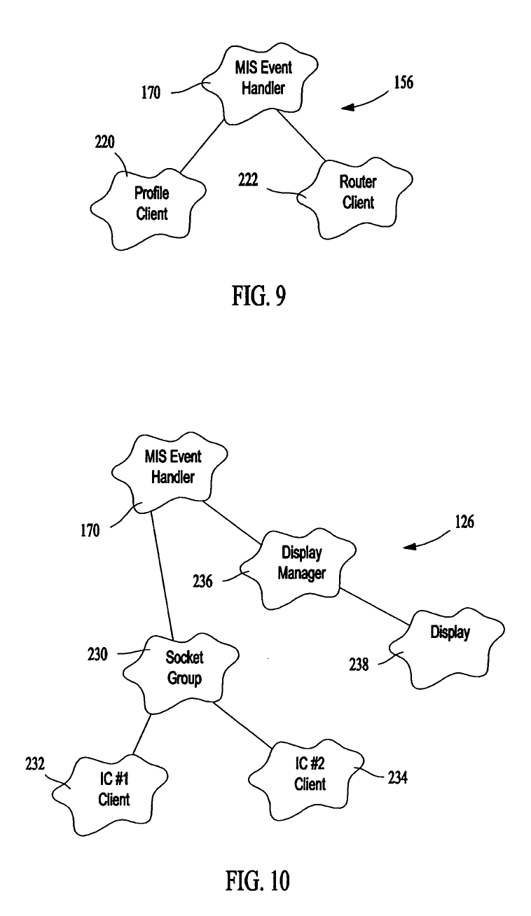

FIG. 9 is an architecture of Control and Logic 156 and includes MIS Event handler 170 connected to a Profile Client 220 and a Router Client 222. Control & Logic 156 provides logic for combining as-run (EventOccurred) messages from each driver 220 and 222 into a summary as-run message per event.

FIG. 10 is an architecture of Redundant On-Air Server 126 including MIS Event Handler 170 connected to a Socket Group 230 which is connected to IC #1 Client 232 and IC #2 Client 234. MIS Event handler is also connected to a Display Manager 236 which is connected to Display 238. Redundant On-Air Server 126 is implemented using the same MIS Event Handler/Display Architecture used by ICs. For Redundant On-Air Server 126, there is a single, simple display object which resembles the IC's Integrated Schedule display. Socket Group 230 handles SocketConnect messages from ICs by creating a new Client object and opening the appropriate socket connection to the requester, thus providing a simple connection protocol for ICs. The simple connection protocol in one embodiment, is extended to create and configure an-appropriate filter node that limits the messages sent to IC Server 152 (shown in FIG. 4). This embodiment provides a simple subscription mechanism.

V. Studio IC Architecture

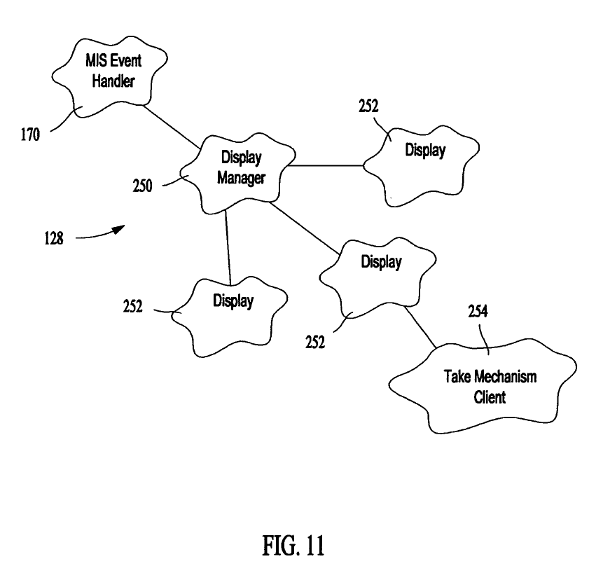

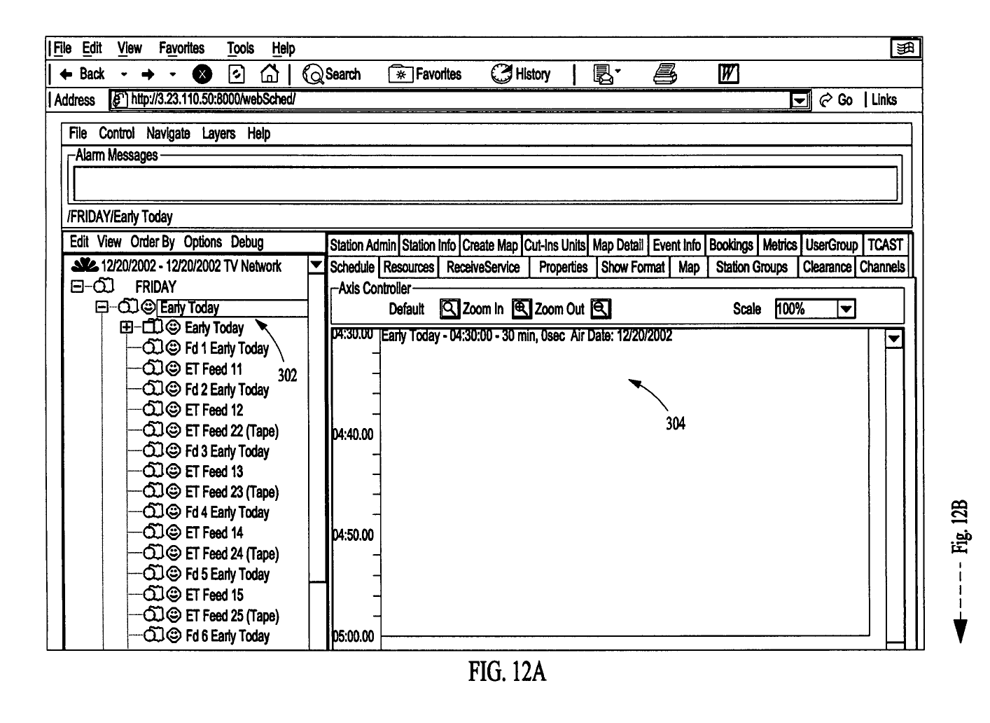

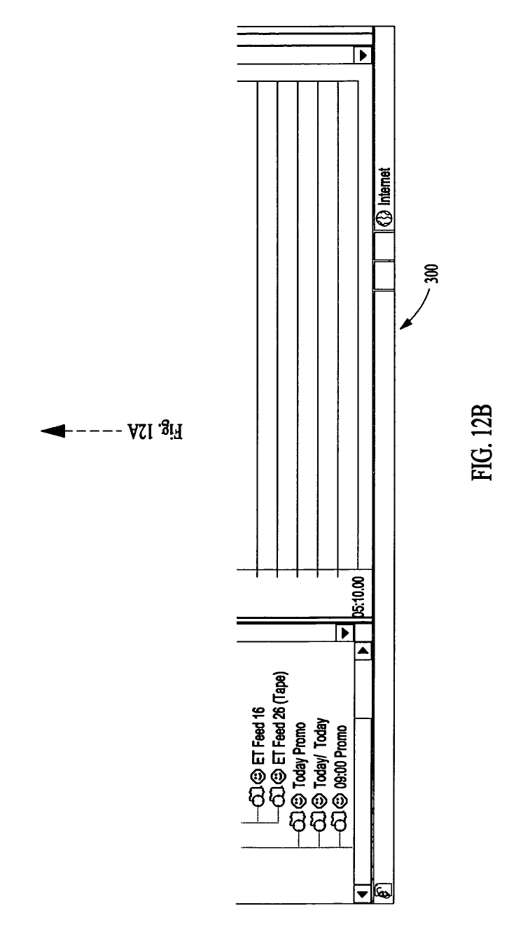

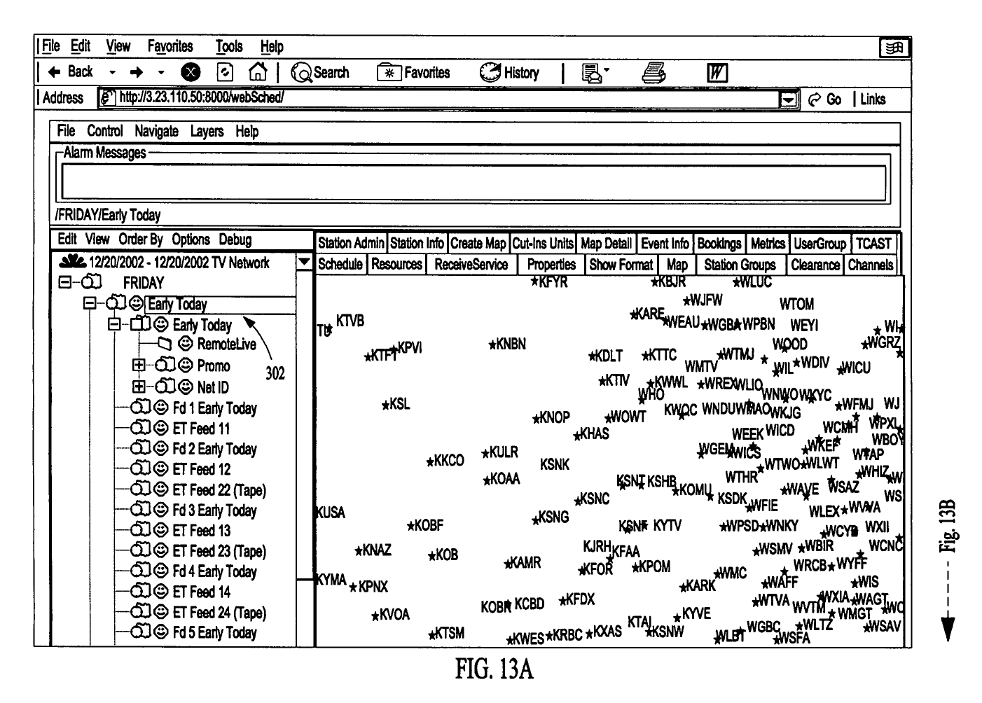

FIG. 11 illustrates an architecture for Studio IC 128 including MIS Event Handler 170 connected to a Display Manager 250 which is connected to a plurality of Displays 252, one of which is connected to a Redundant On-Air Server Client 254. Studio IC 128 is identical to any other IC, except that a typical IC's channel filter is configured to receive messages for only a single channel (the main net), and the User Interface displays only show events for this one channel. Studio IC 128 includes a Client node which passes its Take messages to the Redundant On-Air Server, rather than processing these locally. This Client node receives Take messages from the take button located on the On-Air/Next-Event display.

The above described system architecture provides the IC with a great deal of flexibility and reconfigurability. The Redundant On-Air Server is the working portion of an n-channel IC, and a similar architecture could implement a 40-channel IC running on the fault-tolerant non-stop box. The Studio IC is the UI portion of the IC running on a remote PC. A similar architecture can be used if the non-UI Integration Controller functionality is moved from the PC platform to the non-stop box.

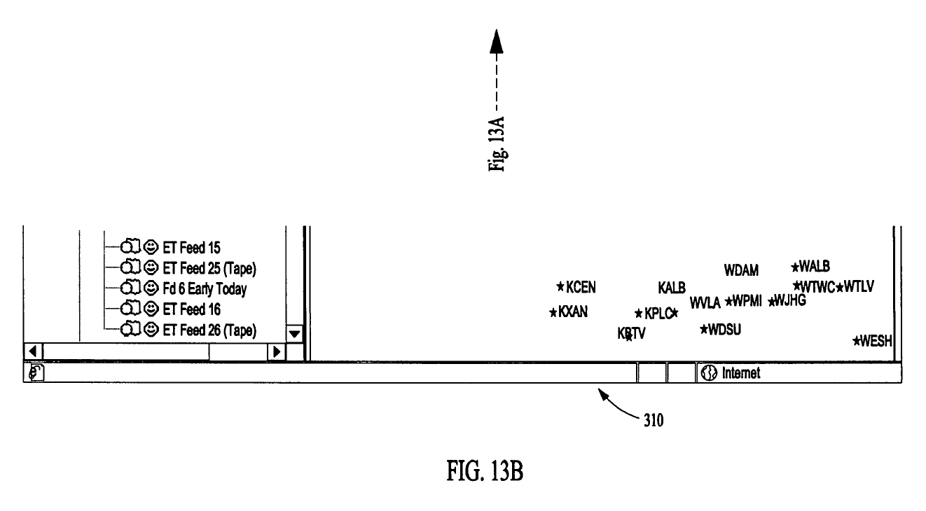

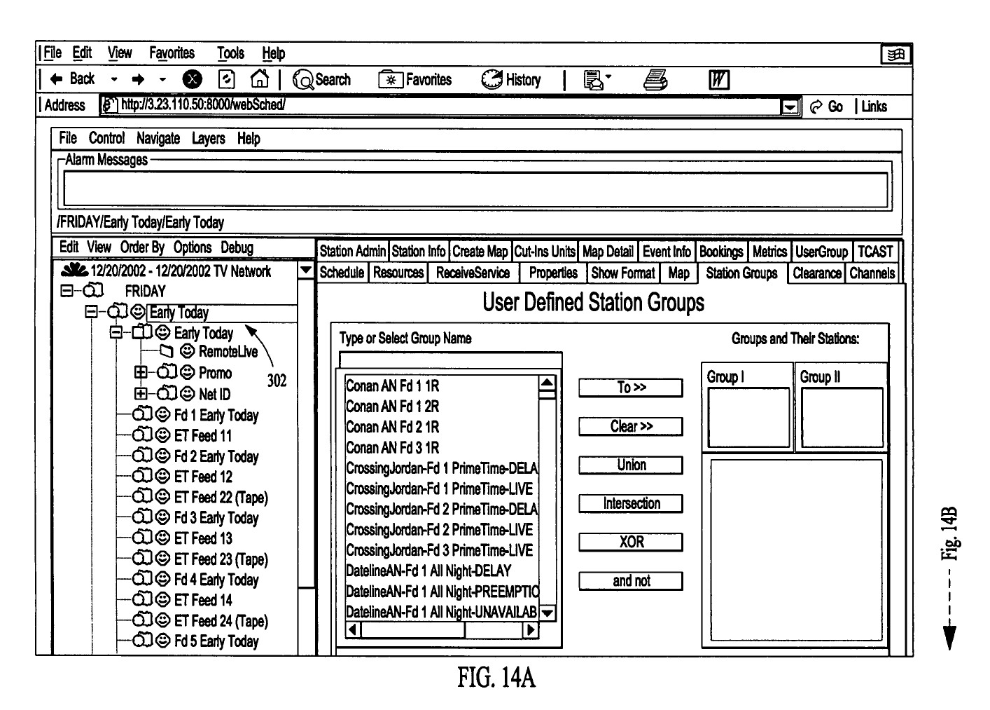

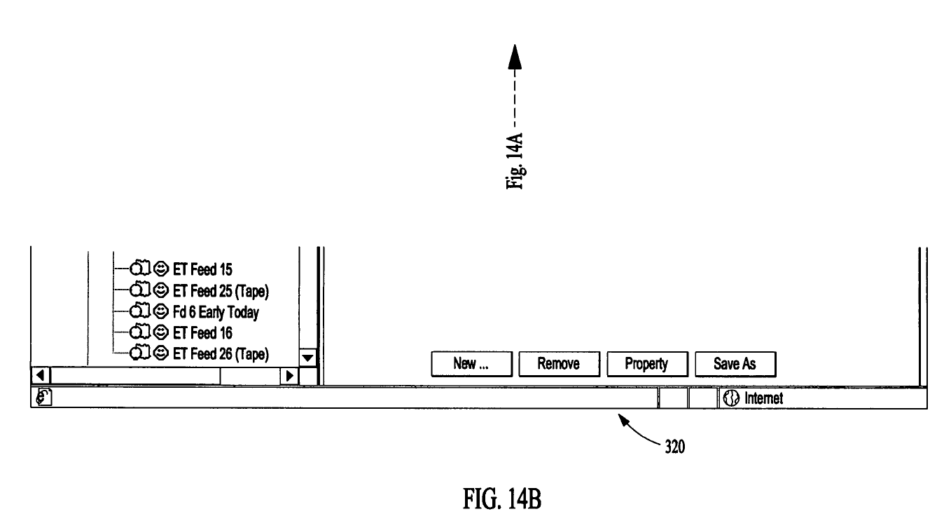

FIGS. 12-14 illustrate example screen shots displayed by a scheduler system, e.g., system 100 shown in FIG. 2. FIG. 12 is a schedule screen 300 including a highlighted entry 302. Schedule details regarding the highlighted entry appear in a display section 304. FIG. 13 is a map screen 310 illustrating station feeds for highlighted entry 302. FIG. 14 is a screen 320 illustrating station groups for highlighted entry 302. The screen shots allow a user to obtain the pertinent information regarding a scheduled event and change the information as appropriate.

While the invention has been described in terms of various specific embodiments, those skilled in the art will recognize that the invention can be practiced with modification within the spirit and scope of the claims.

What is claimed is:

1. A television network broadcast system comprises a scheduling component comprising:
a user interface accessible by all users who contribute to the creation of a schedule; and
a plurality of nodes configured to perform actions based on receipt of messages, said nodes comprising at least one of groups, filters, clients, and servers, the actions include at least one of pass the message along, take a specific action based on receipt of a specific message, block certain types of messages, and initiate new messages.

2. A broadcast system in accordance with claim 1 further comprising:
a Redundant On-Air Server component connected to the scheduling component; and
at least one Integration Controller component connected to the Redundant On-Air Server component.

3. A broadcast system in accordance with claim 2 wherein said Integration Controller component is configured to accept events from the scheduling component and forward these events to real-time systems for frame accurate execution.

4. A broadcast system in accordance with claim 2 wherein said Redundant On-Air Server component comprises a cache of composition event data for said Integration Controller components.

5. A broadcast system in accordance with claim 2 wherein said at least one Integration Controller comprises a Studio IC component configured to provide a subset of the integration Controller component functionality including the ability to perform Takes at a studio location.

6. A broadcast system in accordance with claim 2 wherein said Integration Controller component comprises:
a Server component;
a User Interface component;
a Control & Logic component;
a Profile Driver component connected to said Control & Logic component; and
a Router component connected to said Control & Logic component.

7. A broadcast system in accordance with claim 6 wherein said Server component is configured as an entry point for messages into said Integration Controller component.

8. A broadcast system in accordance with claim 6 wherein said User Interface component is configured to receive status information from said Server component.

9. A broadcast system in accordance with claim 6 wherein said Control & Logic is configured to receive event data from said Server component and distribute this data to device drivers.

10. A broadcast system in accordance with claim 6 wherein said User Interface component comprises:
an MIS Event Handler component;
a Display Manager component connected to said MIS Event Handler; and
at least one Display component connected to said Display Manager component.

11. A broadcast system in accordance with claim 10 wherein said MIS Event Handler component comprises:
an MIS Server component;
an Insert Message Filter component connected to said MIS Server component;
a Channel Filter component connected to said insert Message Filter component;
an Event Edit Filter component connected to said Channel Filter component;
a Purpose Contingency Filter component connected to said Event Edit Filter component;
an Event List Manager component connected to said Purpose Contingency Filter component; and
an MIS Event Handler Group component connected to said Event List Manager component.

12. A broadcast system in accordance with claim 11 wherein said Insert Message Filter component is configured to receive messages from other nodes within said User Interface component.

13. A broadcast system in accordance with claim 11 wherein said Event Edit Filter component comprises an in-memory cache of event data.

14. A broadcast system in accordance with claim 11 wherein said Purpose Contingency Filter component is configured to track active contingencies.

15. A broadcast system in accordance with claim 11 wherein said Event List Manager component is configured to perform at least one of simulating execution of events, providing transitions and countdowns, supporting Takes, and providing event list data integrity checks.

16. A broadcast system in accordance with claim 11 wherein said Event list Manager component is configured to implement event trigger type logic for at least one of real, approximate, tied, and offset.

17. A broadcast system in accordance with claim 6 wherein said Server component comprises:
an MIS Event Handler component;
a User Interface Client component connected to said MIS Event Handler component; and
a Control & Logic Client component connected to said MIS Event Handler component.

18. A broadcast system in accordance with claim 6 wherein said Control & Logic component comprises:
an MIS Event Handler component;
a Profile Client component connected to said MIS Event Handler component; and
a Router Client component connected to said MIS Event Handler component.

19. A broadcast system in accordance with claim 2 wherein said Redundant On-Air Server comprises:
an MIS Event Handler component;
a Socket Group component connected to said MIS Event Handler component;
an Integration Controller #1 Client component connected to said Socket Group component; and
an Integration Controller #2 component connected to said Socket Group component.

20. A system in accordance with claim 2 wherein said Studio IC component comprises:
an MIS Event Handler component;
a Display Manager component connected to said MIS Event Handler component;
at least one Display connected to said display Manager; and
a Redundant On-Air Server connected to one of said Display components.

21. A method of scheduling events utilizing a television network broadcast system including a scheduling component configured with a user interface accessible by all users who contribute to the creation of a schedule, and a plurality of nodes configured to perform actions based on receipt of messages, said nodes comprising at least one of groups, filters, clients, and servers, the actions include at least one of pass the message along, take a specific action based on receipt of a specific message, block certain types of messages, and initiate new messages, said method comprising utilizing an Integration Controller component to accept events from the scheduling component and forward these events to real-time systems for frame accurate execution.

22. A method in accordance with claim 21 further comprising utilizing the Integration Controller to monitor return messages, update displays accordingly, and forward pertinent information to the scheduling component for display and appropriate operator action as needed.

23. A method in accordance with claim 21 wherein the Integration Controller includes a Studio IC component that performs Takes at a studio location.

24. A method in accordance with claim 21 wherein a Redundant On-Air Server component is connected to the Integration Controller, the Redundant On-Air Server component receives Take messages, performs edits to the Taken event and all of its tied and offset events, and distributes Process Event messages for events that have been updated by the Take.

25. A method in accordance with claim 21 wherein the Integration Controller includes a User Interface component, the User Interface component receives Process Event, Take, and SwitchList messages.

26. A method in accordance with claim 21 wherein the Integration Controller includes an Integration Controller server connected to a Control & Logic component, the Control & Logic component receives event data from the Integration Controller Server component and distributes this data to device drivers.

27. A method in accordance with claim 25 wherein the User Interface component displays the execution of events and information such as material management and device status.

28. A method in accordance with claim 25 wherein the User Interface component includes an MIS Event Handler component having an Insert Message Filter that passes all messages originating from a previous stage through the filter unchanged.

29. A method in accordance with claim 25 wherein the User Interface component includes an MIS Event Handler component having a Channel Filter that passes all messages unchanged except that each ProcessEvent message, if it contains a composition event, is only allowed to pass if that event's channel is one of the channels to be handled by the Integration Controller.

30. A method in accordance with claim 25 wherein the User Interface component includes an MIS Event Handler component having an Event List Manager that simulates the execution of events, provides event transitions and countdowns, supports Takes, and provides event list data integrity checks.

31. A method in accordance with claim 21 wherein the Integration Controller includes a Display Manager that translates system messages into commands that update User Interface displays.

32. A method in accordance with claim 21 wherein the Integration Controller includes a Display Manager that mediates among the displays such that the displays coordinate with each other through the Display Manager rather than directly communicating with one another.
